(19) United States
(12) Patent Application Publication
(10) Pub. No.: US 2010/0159236 A1
(43) Pub. Date: Jun. 24, 2010

(54) INTERFACIAL STRENGTHENING AND TOUGHENING USING A MOLECULAR NANOLAYER

(75) Inventors: Ramanath Ganapathiraman, Niskayuna, NY (US); Darshan D. Gandhi, Redondo Beach, CA (US)

Correspondence Address: FOLEY AND LARDNER LLP;SUITE 500, 3000 K STREET NW, WASHINGTON, DC, 20007, US

(73) Assignee: Rensselaer Polytechnic Institute

(21) Appl. No.: 12/515,659

(22) PCT Filed: Nov. 21, 2007
(86) PCT No.: PCT/US07/24276

§ 371 Date: Jan. 22, 2010

Related U.S. Application Data
(60) Provisional application No. 60/860,778, filed on Nov. 22, 2006.

(51) Int. Cl. B32B 7/04; B32B 37/00

(52) U.S. Cl. 428/332; 156/299

(57) ABSTRACT

An article includes a first surface, a second surface, and a molecular nanolayer located at an interface between the first and the second surface, where an interface toughness is a higher than 20 J m⁻².

### CROSS-REFERENCE TO RELATED PATENT APPLICATIONS

This application claims benefit of priority of U.S. Provisional Application Ser. No. 60/860,778, filed on Nov. 22, 2006, which is incorporated herein by reference in its entirety.

### STATEMENT REGARDING FEDERALLY-SPONSORED RESEARCH OR DEVELOPMENT

This invention was made with U.S. Government support under grant number DMR 0519081 and ECS 0501488 awarded by the National Science Foundation. The U.S. Government has certain rights in the invention.

### BACKGROUND OF THE INVENTION

Self-assembled molecular nanolayers (MNLs), comprised of short organic chains terminated with chosen terminal groups are attractive for modifying surface properties for a variety of diverse applications. Examples include organosilane MNLs used as lubricants in microelectromechanical devices or for nanoscale photo- and electron-beam lithography, and thiol-terminated MNLs for corrosion protection or biomineralization of inorganic crystals. Recent works have opened up new, potentially revolutionary, uses of MNLs at thin film interfaces as active nanodevice components e.g., as low-switching voltage gate dielectric layer for molecular devices, or as passive barrier layers that enhance chemical stability, e.g., to inhibit interfacial diffusion, promote adhesion and toughen brittle nanoporous structures (see Ferguson, P. G. et al., Science 253, 776-778 (1991), Ramanath, G. et al., Appl. Phys. Lett. 83, 383-385 (2003), Maidenberg, D. A. et al., Nat. Mater. 3, 464-469 (2004)). However, the thermal stability of bare MNLs is constrained by molecular desorption typically in the range of 350-400° C. (see Ishida, T et al., Langmuir 18, 83-92 (2002), Senkevich, J. j. et al., Colloids Surf, A 207, 139-145 (2002), Kluth, G., et al., Langmuir 13, 3775-3780 (1997).) This relatively low thermal stability of MNLs was widely considered as a major challenge and limited the use of MNLs in applications that entail high temperature processing.

### SUMMARY OF THE INVENTION

An embodiment of the invention provides an article comprising a first surface, a second surface, and a molecular nanolayer located at an interface between the first and the second surface, wherein an interface toughness is higher than 20 J m⁻².

### BRIEF DESCRIPTION OF THE DRAWINGS

FIG. 1 shows the effect of thermal annealing on the interface toughness of Cu/MPTMS/SiO₂ and Cu/SiO₂ structures. FIG. 1a is a schematic depiction of the four-point-bend test structure. FIG. 1b shows average debond energy G, plotted as a function of annealing temperature Tₐₙₙₑₐₗ, for Cu/MPTMS/SiO₂ and Cu/SiO₂ structures. The dotted line for Cu/MPTMS/SiO₂ structures for Tₐₙₙₑₐₗ>500° C. represents a lower limit of the fracture energy. The first square data point shown at 25° C. corresponds to data from samples that were subject to no annealing treatments. The circle data points are from samples where MPTMS was pre-annealed before Cu deposition. Each data point is an average of measurements on at least six different samples.

FIG. 2 is an X-ray photoelectron spectra from fracture surfaces. FIG. 1a refers to survey scans from samples annealed at Tₐₙₙₑₐₗ≦500° C., and FIG. 1b refers to survey scans from samples annealed at Tₐₙₙₑₐₗ>500° C. Silica fracture surfaces from samples with Tₐₙₙₑₐₗ≦500° C. mainly show Si, 0, and adventitious C, while the Cu fracture surfaces show Cu, 0, and carbon peaks. The example scans for T≦500° C. shown here are from the sample subject to Tₐₙₙₑₐₗ=500° C. anneal, but are identical to that obtained at lower temperatures.

FIG. 3 shows high-resolution XPS spectra from the fracture surfaces. FIG. 3a shows S 2p bands from Cu fracture surfaces obtained by the delamination of Cu/MPTMS/SiO₂ structures after annealing to different temperatures. A reference spectrum from the silica fracture surface is also shown. FIG. 3b shows the representative spectra demonstrating the differences in the Si 2p band positions observed on Cu and silica fracture surfaces, respectively, for Lₐₙₙₑₐₗ≦500° C. A reference spectrum from an MPTMS MNL on Au is also shown. FIG. 3c shows the integrated intensity of S 2p normalized to the Cu 2p signal as a function of Tₐₙₙₑₐₗ showing negligible changes in the S 2p intensity upon annealing.

FIG. 4 shows schematic sketches depicting the mechanism of annealing-induced interfacial toughening. FIG. 4a is a mechanism for Tₐₙₙₑₐₗ<400° C., where almost all molecules attached to the SiO₂ substrate are hydrogen bonded, causing failure at low interface debonding energies. FIG. 4b is a mechanism for Tₐₙₙₑₐₗ not lower than 400° C. The number of covalent linkages increases via siloxane bridging, which strengthens the interface, and leads to increased toughening.

FIG. 5 shows the system energy as a function of molecular stretching for different combinations of siloxane and hydrogen bonds at the MPTMS-silica interface. FIG. 5a is a schematic depiction of an MPTMS molecule bonded to the silica underlayer by one siloxane bridge (i=1, 33% irreversible dehydration) and two hydrogen bonds (j=2). The arrow indicates the direction of stretching. FIG. 5b shows the system energy plotted as a function of Cu-overlayer-silica underlayer separation for three different interface bonding chemistries. Each graph is plotted up to the point of fracture.

### DETAILED DESCRIPTION OF THE PREFERRED EMBODIMENTS

Self-assembled molecular nanolayers (MNLs) are attractive for diverse applications such as nanodevices, lithography, tribology, and biomineralization. The low thermal stability of MNLs, however, is thought to limit their use above 300-400° C. due to molecular desorption from surfaces.

One embodiment of the invention provides a method to enhance interface strength and toughness by strongly bonding the adjacent overlayer with the substrate by using a molecular nanolayers (MNL) comprising of at least one difunctional chemical. An thermal annealing process may or may not be incorporated. Typical MNL thickness can range from 0.5 to 10 nm; optimally 1-2 nm. At least one chemical comprising the MNL can in general be of the type A-(CHₓ—X)ₙ—B, wherein A and B can be same or different terminal groups, and X is an inorganic moiety or element. The terminal groups can be modified and/grafted with different groups as per the desired chemistry. Examples of terminal groups of A and B include, but are not limited to, Si(Y)ₙ (Y can be alkoxy groups ((OCH₃)ₙ) or halides), SH, COOH, CN, NH₂, aromatic termini, CH₃ or CH═CH₂ moieties, or (CHₓ)ₙ containing C—C, C═C or C≡C bonds in aliphatic or aromatic forms in addition to bonds with hydrogen and other elements in branched or linear configurations in periodic or non-periodic arrangements. Strong interfacial bonding can be achieved either by physical and/or chemical mechanisms that occur either during the MNL deposition and/or during post-deposition processing treatments such as thermal annealing. The choice of the functional chemistry is dependent on the overlayer and substrate in consideration. While the example described below uses linear MNLs, the interfacial toughening can be achieved by using MNLs involving branched or multilayer configurations.

This invention encompasses strengthening and toughening of interfaces between similar and/or dissimilar materials such as organic, inorganic (including metal, ceramic and/or semiconductor), or combinations thereof. It can be used in plastic electronics, molecular sensors, and molecular electronics, and other applications in which the formation of strong interfaces between same or different surfaces, such as thin film surfaces, is preferred.

Embodiments of this invention provide methods to strengthen and toughen interfaces by using a molecular nanolayer having a thickness range of a few nm to a several microns such as 0.5 nm to 2 μm, preferably less than 1 micron, for example 1 to 10 nm. It may or may not be applied in combination with thermal annealing treatments. For example, one embodiment of this invention enabled a factor-of-5 increase in toughness of Cu-silica interfaces by incorporating a nanometer-thick molecular layer, 3-mercapto-propyl-tri-methoxy-silane (MPTMS) and annealing to 400-700° C. The Cu overlayer suppresses molecular desorption due to Cu—S bonding and activates annealing-induced siloxane bridging at the MPTMS-silica interface. Without wishing to be bound to a particular theory, the inventors believe that the strong bonds at the Cu-MNL and MNL-silica interfaces increase the debond energy, and additionally provide the framework for toughening by facilitating molecular stretching and energy transfer to the adjacent layers. The approach of using a nanolayer interfacial toughener offers promise to obviate thicker adhesion promoters currently used, and open up new possibilities for molecular level tailoring of thin film interface stability by exploiting high-temperature interactions and integrating MNLs into micro- and nano-device technologies.

This strengthening of interfaces using molecular nanoglue is not limited to metal-dielectric interfaces demonstrated here, and can be applied to metal-metal, metal-polymer, polymer-polymer, metal-ceramic, etc., or a combination of thereof, by carefully choosing the molecular nanolayer termini, length, and chemistry based on the overlayer and the underlayer. For example, similar interfacial toughening can be achieved by replacing the methoxy group in silane moiety with a halide containing species. The thiol termini can be replaced by a functional group that forms a strong covalent bond with the copper overlayer, such as -carboxyl groups as demonstrated in our previous reports. The choice of terminal chemistry (or sub-units in the MNLs) can be varied or modified by grafting desired groups depending on the overlayer. Furthermore, while the interfacial toughening strategy demonstrated here uses linear MNLs, MNLs involving branched or multilayer configurations can be employed in particular cases. This technique can be used in plastic electronics, molecular sensors, and molecular electronics, and other applications in which the formation of extremely strong, isolated interfaces between similar or dissimilar films is preferred.

As an example, annealing Cu/MNL/SiO₂ thin films at 400° C.≦Tₐₙₙₑₐₗ≦700° C. result in a 5-fold enhancement in interface toughness (compared to pristine Cu/SiO₂ interfaces), yielding remarkable values exceeding ˜20 J m⁻². Although similarly high interface toughness values can be obtained using micrometer-thick interfacial layers, interface toughening by annealing an interfacial molecular nanolayer at high temperatures, is unprecedented to the best of our knowledge. Electron spectroscopy of fracture surfaces and density functional theory calculations of molecular stretching and fracture show that our approach relies mainly on creating and exploiting strong chemical bonding between the MNL termini and the adjacent layers. Our findings therefore open up new opportunities for molecular level tailoring of thin film interface toughness by annealing MNLs at temperatures higher than previously envisaged, for obviating thick adhesion promoters, and for integrating MNLs into applications (e.g., nanodevices) where thick microlayers are not a viable option.

Molecular nanolayers of 3-mercapto-propyl-tri-methoxy-silane (MPTMS) were adsorbed by immersing an oxidized silicon substrate in an MPTMS solution. Device quality n-type Si(001) wafers with a 85-nm-thick thermal oxide cap layer were cleaned with xylene, acetone, isopropanol and de-ionized water, and treated with a mixture of 70% H₂SO₄-30% H₂O₂ at 60° C. for 30 minutes to form hydroxyl groups on the surface. The wafers were then dipped in a 5 mM solution of MPTMS in toluene for 30 minutes. Excess and loosely bound MPTMS molecules were removed by rinsing successively in toluene, chloroform, methanol and DI water. Variable angle spectroscopic ellipsometry and variable take-off angle X-ray photoelectron spectroscopy (XPS) measurements showed that MPTMS MNLs are 0.9±0.1 nm thick, with the thiol termini pointing outwards. The MNL thickness is in good agreement with the theoretical length of the MPTMS molecules, confirming the formation of a single monolayer.

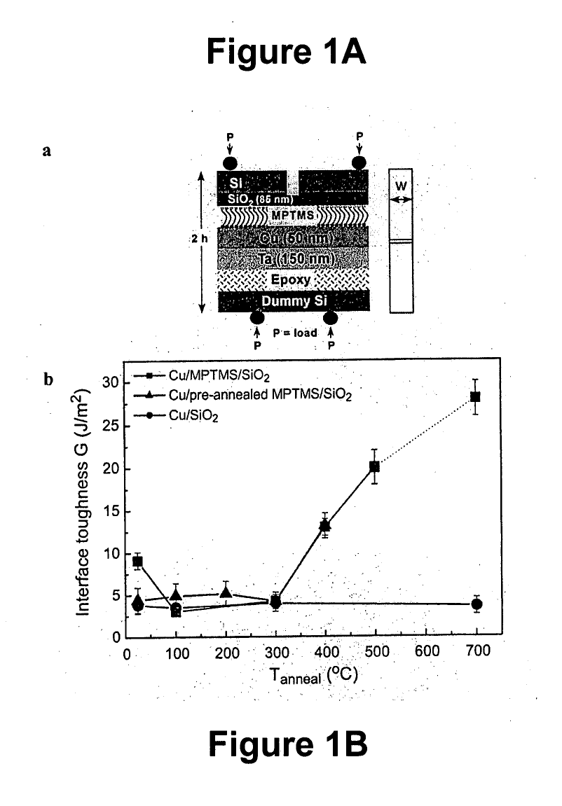

After MPTMS MNL formation, the samples were divided into two sets. One set was annealed in air for 10 minutes at 100° C. prior to Cu deposition. XPS showed no observable oxidation of the thiol termini upon this pre-annealing treatment. Thereafter, both sets were subject similar processing. Layers of 50-nm-thick Cu and 150-nm-thick Ta were sputter-deposited successively on the MPTMS MNLs in a CVC DC Magnetron tool, without vacuum break. A 150-nm-thick Ta layer was included because the adhesion between Cu and epoxy interface is poor and fails prior to fracture at the Cu/MPTMS/silica, which is the interface of interest. Selected samples were annealed in a 5×10⁻⁷ Torr vacuum furnace at different temperatures, Tₐₙₙₑₐₗ between 100 and 700° C. for 30 minutes. Samples without any annealing treatments were also investigated. The samples were then glued with an epoxy onto a dummy Si wafer in a face-to-face configuration, to obtain Si(001)/epoxy/Ta/Cu/MPTMS/SiO₂/Si structures. The samples were then diced using a dicing saw into pieces for 5 mm×40 mm dimensions. A notch was created on wafer with the MNL for four-point bend adhesion testing. Four-point bending fracture tests (see Ramanath, G. et al., Appl. Phys. Lett. 83, 383-385 (2003), and Dauskardt, R. H., Eng. Fract. Mech. 61, 141-162 (1998)) were carried out on thin film sandwiches of Si/epoxy/Ta/Cu/MPTMS/SiO₂/Si structures (see FIG. 1a) to determine the interface toughness G, which is also referred to as the interface debond energy, or the strain energy release rate. FIG. 1b shows the debond energies for Cu/MPTMS/SiO₂ and Cu/SiO₂ structures annealed between 100 and 700° C.

As-prepared thin film structures with pristine Cu/SiO₂ interfaces, i.e., without MPTMS MNLs, exhibit an average debond energy G_{reference}=3.8±1 J m⁻². There is no observable change in toughness upon annealing. MPTMS-treated interfaces at room temperature show up to a factor-of-3 higher interface toughness, G_{MPTMS}=9.1±1 J m⁻², in agreement with our earlier report (see Ramanath, G. et al., Appl. Phys. Lett. 83, 383-385 (2003).). Annealing the MPTMS-treated samples between 100° C.—≦Tₐₙₙₑₐₗ<400° C. decreases G_{MPTMS} to 3.5±1 J m⁻². For Tₐₙₙₑₐₗ greater than 400° C., however, we observe a monotonic increase in G_{MPTMS} At 500° C., G_{MPTMS}=20±2 Jm⁻² at, which is more than five times larger than that measured for Cu—SiO₂ interfaces without a MNL. Such colossal interfacial toughening through the use of a nanometer-thick molecular layer is believed to be unprecedented. Furthermore, our finding is particularly remarkable considering that toughening is achieved by annealing the samples with MPTMS at temperatures above which MPTMS is known to thermally desorb, e.g., 350-400° C. (see Senkevich, J. J. et al., Colloids Surf, A 207, 139-145 (2002).). Our approach of using nanolayers at interfaces, combined with thermal annealing, therefore, offers a completely new alternative to micrometer-thick metallic (see Lane, M. et al., J. Mater. Res. 15, 203-211 (2000).) or polymeric (see Litteken C. S. et al., Int. J. Frac. 119/120, 475-485 (2003).) layers currently used to obtain similar toughness values (see Evens, A. G. et al., Metall. Transactions A, 21A, 2419-2429 (1990), Lane, M. et al., Annu. Rev. Mater. Res. 33, 29-54 (2003).). We demonstrate below that the bonding between the thiol termini of the MPTMS MNL and the Cu overlayer inhibits molecular desorption, and allows toughening to occur by annealing-induced MNL-silica interface strengthening via siloxane bridging.

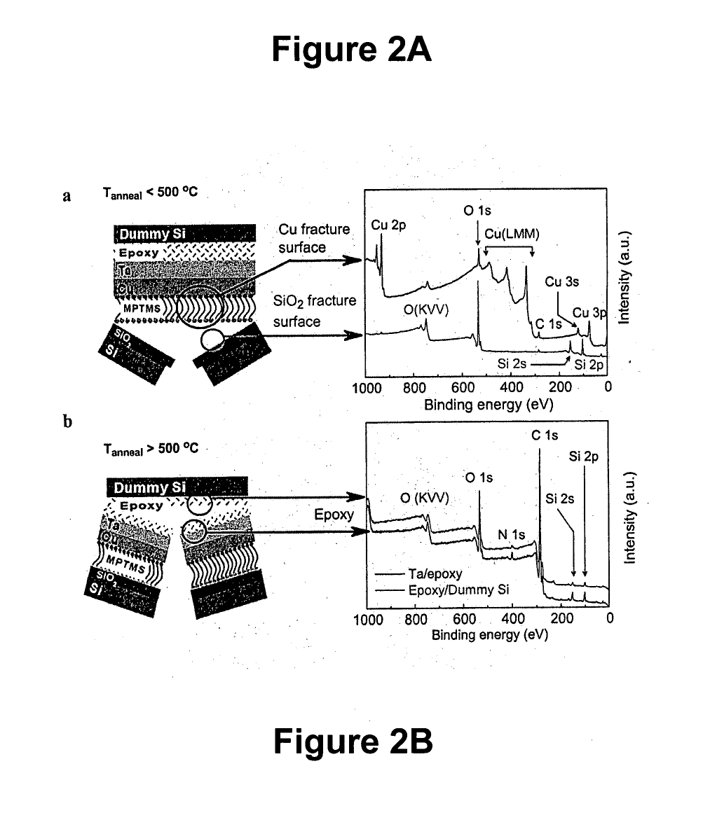

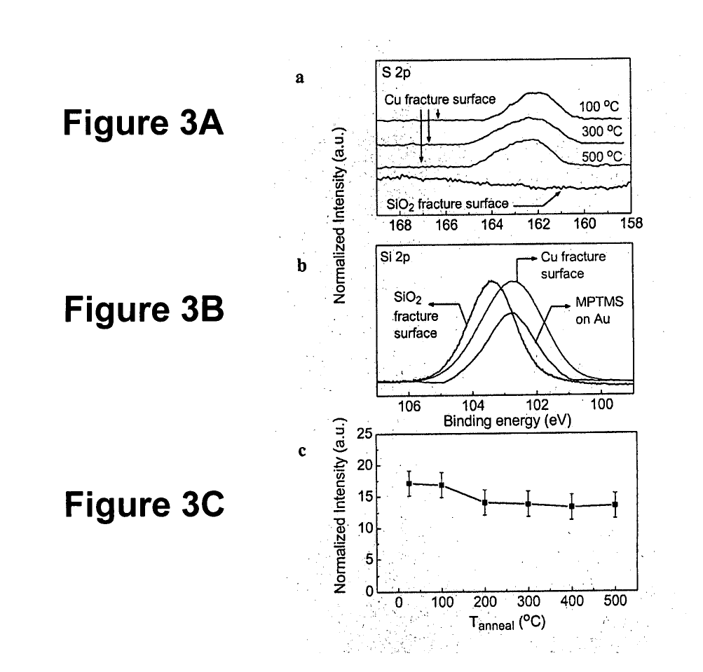

For Tₐₙₙₑₐₗ≦500° C. delamination occurs at the Cu/MPTMS/SiO₂ interface, as revealed by XPS spectra (see FIG. 2a) from the two fracture surfaces showing spectral signatures of Cu (from the Cu fracture surface), and silicon and oxygen (from silica), respectively. The S 2p signal from the nanometer-thick MNL of MPTMS is below the detection limit in survey spectra in FIG. 2, but is discernible in the multiplex scans shown in FIG. 3. The interface debond energy measured from samples with MPTMS MNLs subject to pre-annealing treatment at 100° C. prior to Cu deposition follow a similar trend, but with a key difference. No interface toughening is observed in the Cu/MPTMS/SiO₂ structure with the pre-annealed MPTMS, in contrast to the three-fold toughness increase observed in samples with MPTMS MNLs without the pre-anneal. The reason for this difference is discussed later.

For Tₐₙₙₑₐₗ>500° C., fracture occurs cohesively inside the epoxy in the Si/epoxy/Ta/Cu/MPTMS/SiO₂/Si structure, instead of the Cu/MPTMS/SiO₂ interface. This is clear from the XPS spectra (e.g., see FIG. 2b) from the two fracture surfaces consistently showing identical core-level peaks, indistinguishable from that obtained from the epoxy. Neither fracture surface shows any Cu 2p or S 2p bands. Cohesive failure in the epoxy for Tₐₙₙₑₐₗ>500° C. suggests that the Cu/MPTMS/SiO₂ interface may not be the weakest one. Presently it is unknown if fracture in the epoxy corresponds to the energetically most favorable pathway, or determined by the dynamics of crack propagation. If we assume that epoxy fracture occurs by the energetically most favored path in structures annealed to 700° C., the Cu/MPTMS/SiO₂ interface toughness is at least 28 J m⁻² (measured for epoxy failure), corresponding to 7-fold toughening. In this scenario, the debond energies measured for Tₐₙₙₑₐₗ>500° C. provide only a lower limit of the Cu/MPTMS/SiO₂ interface toughness, and hence are denoted by a dotted line in FIG. 1b.

Based upon XPS analysis of fracture surfaces combined with density functional theory calculations of molecular stretching and fracture, without wishing to be bound to a particular theory, we believe that strong chemical coupling at the Cu-MNL and MNL-silica interfaces provide the primary mechanism for interface toughening. We find that while Cu—S bonding occurs at room temperature, stable siloxane bridges are formed at the methoxysilane-SiO₂ interface only upon annealing above 400° C. The strong interfacial bonding enables toughening by increasing the work of adhesion, which is a necessary condition to activate secondary mechanisms such as molecular stretching and efficient energy transfer to the adjacent layers, e.g., through constrained plastic deformation in the copper layer. The grain size and texture of the annealed and as-prepared Cu films are identical within experimental uncertainty, ruling out the possibility of toughening due to increased plastic deformation resulting from annealing-induced grain growth.

FIGS. 3a and 3b show the S 2p and Si 2p core-level bands from the Cu and silica fracture surfaces, respectively. For Tₐₙₙₑₐₗ≦500° C., the S 2p core-level signature from the thiol in the MPTMS molecule is seen only on the Cu fracture surface, and not on the silica fracture surface. The S 2p band at 161.2 eV is due to Cu—S bonding between the thiol termini and the Cu overlayer. On the Cu fracture surface, the Si 2p bands centered at 102.8 eV correspond to the methoxysilanes in MPTMS26, unlike the silica fracture surface where the Si 2p band is centered at 103.4 eV. The Si 2p spectral signature from the Cu fracture surface is identical to that seen in outward-pointing methoxysilanes in MPTMS MNLs bound to a Au surface via thioligation (see FIG. 3b). These observations indicate that delamination occurs at the MPTMS-SiO₂ interface for Tₐₙₙₑₐₗ≦500° C. The strong thioligation of Cu with MPTMS achieved in the as-prepared samples prevents molecular desorption, but cannot explain the large annealing-induced interface toughening because core level Cu 2p and S 2p bands are identical for different Tₐₙₙₑₐₗ (see FIG. 3c). Moreover, annealing MPTMS/silica structures before, or after, Cu deposition (see FIG. 1b) result in identical changes in the toughness behavior of Cu/MPTMS/silica structures, indicating that annealing-induced toughness is predominantly due to chemical changes at the MPTMS-silica interface. In particular, we show below that both annealing-induced interface weakening for Tₐₙₙₑₐₗ<400° C., and colossal interface toughening for Tₐₙₙₑₐₗ>400° C., are due to siloxane (Si—O—Si) bond disruption, and stabilization, respectively, at the MPTMS-silica interface.

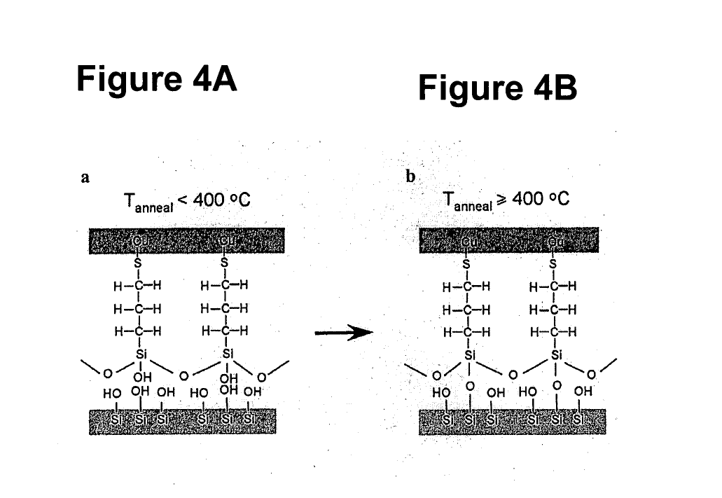

Prior work of the self assembled monolayer on silica glasses has shown that siloxane (Si—O—Si) bonds formed by the dehydration of silanol (Si—OH) groups below 400° C. are strained and susceptible to rehydration, and revert to silanols upon cooling. We expect such reversion of strained siloxane bridges into silanols at the MNL-silica interface to decrease the Cu/MPTMS/silica interface toughness, as we indeed observe for 100° C. Tₐₙₙₑₐₗ<400° C. Siloxane bond breakage does not occur in MPTMS MNLs that are not subject to any annealing treatment presumably because of the low thermal activation for siloxane bond breakage by hydration at room temperature. For Tₐₙₙₑₐₗ not lower than 400° C. the scenario is completely different because of the onset of irreversible dehydration, i.e., formation of strain-relaxed siloxane bridges that do not revert to silanol groups upon cooling. Without wishing to be bound to a particular theory, it is believed that the resultant increase in the number of strain-free siloxane bridges provides the primary mechanism for interface toughening, as explained later. The monotonic toughness increase with increasing Tₐₙₙₑₐₗ is likely due to the increase in the number of siloxane bridges formed via dehydration, i.e., increase in the extent of irreversible dehydration with annealing temperature. FIG. 4 depicts key features of the interfacial reactions responsible for annealing-induced interfacial weakening below 400° C., and toughening above 400° C.

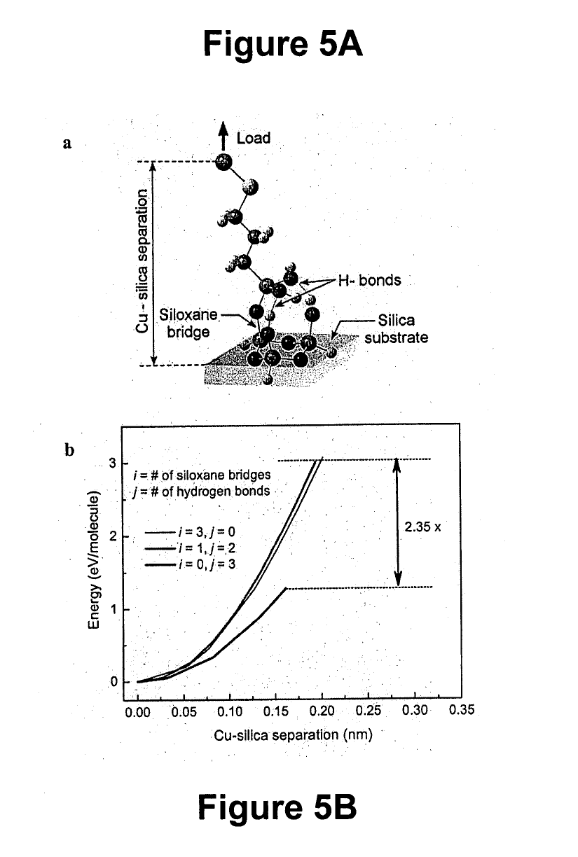

Without wishing to be bound to a particular theory, it is believed that the attribution of interface toughening to siloxane bridging at the MPTMS-silica interface is supported by the energetics of stretching of an individual MPTMS molecule, determined by first principles density functional theory calculations. We constrained an MPTMS molecule between a Cu overlayer and silica underlayer (see FIG. 5a). The Cu was thioligated and the methoxy groups in MPTMS were bound to silica via different number of covalent siloxane bridges i and hydrogen bonds j, such that 0≦i≦3, and j=3−i. The system energy was calculated as a function of Cu-silica separation after optimizing the molecule to the ground state for each interface chemistry configuration.

FIG. 5b plots the system energy vs. Cu-silica separation for three representative bonding configurations at the MPTMS-silica interface: for i=0, 1 and 3; and j=3−i. For MPTMS molecules anchored to silica by hydrogen bonding (i=0, no siloxane bonds, 0% irreversible dehydration), fracture occurs at the MPTMS-SiO₂ interface. This result is consistent with XPS fracture surface analysis of samples showing lowest interface toughness G_{MPTMS}˜3 J m⁻², e.g., for 100° C.≦Tₐₙₙₑₐₗ<400° C. Introducing even one siloxane bond (i>1, 33% irreversible dehydration) shifts the point of bond fracture to the Cu-MPTMS interface and increases the fracture energy by more than a factor of 2.35, underscoring the central role of siloxane bridging on interface toughening. These results, therefore, clearly support our attribution of the experimentally observed toughening to irreversible siloxane bridging for Tₐₙₙₑₐₗ not lower than 400° C. Displacing the other two hydrogen bonds (equivalent to 67% and 100% irreversible dehydration) with siloxane bridges in our theoretical calculations does not result in further toughening, suggesting that one siloxane bridge (33% irreversible hydration) for each MPTMS molecule with the silica underlayer is sufficient to provide toughening. Without wishing to be bound to a particular theory, it is therefore believed that irreversible siloxane bridging is an important toughening mechanism, and provide an estimate of the degree of irreversibility for a single molecule.

The experimentally measured fracture toughness consists of a number of different energy absorbing processes. The most fundamental of these is the work of adhesion which relates directly to the chemical bonding at the Cu/MNL/silica interface. Interface bond strengthening not only enhances the work of adhesion, but also is a necessary condition for the activation of secondary energy absorption processes, e.g., molecular stretching, lateral molecular interactions, and plastic energy dissipation in adjacent films. Since our results show that Cu—S bonds at the interface are insensitive to thermal annealing, we propose that annealing-induced siloxane bridging is the primary toughening mechanism. However, siloxane-bridging-induced adhesion increase need not necessarily be the largest contributor to the fracture toughness, when compared to the secondary energy absorption processes enabled by the increased interfacial strength. For example, it has been shown that local plastic deformation-induced toughening enabled by increased work of adhesion can often be a factor of 2-10 greater than that of the work of adhesion itself, depending on the material stack. Determination of the siloxane bond density in the MNLs as a function of Tₐₙₙₑₐₗ and environmental factors should shed light on assessing the direct contribution of silica bridging towards fracture toughness via increased work of adhesion. We further note that the theoretical prediction of failure at the Cu-MPTMS interface upon siloxane bridging is contrary to our experimentally observed failure at the MPTMS-silica interface for T≦500° C., despite the bond energies of C—C (6.3 eV) and Cu—S (2.86 eV) being significantly lower than that of Si—O (8.3 eV). This apparent discrepancy is due to our theoretical calculations not accounting for the influence of environmental factors such as pH and moisture, which are expected to prematurely break siloxane bonds, e.g., by stress corrosion cracking in our experiments.

In summary, a molecular nanolayer was used to toughen and strengthen interface between same or different surfaces was described. In the demonstrative example, an enhancement of the toughness by a factor of 5-7 was achieved. Thermal annealing was used to form stronger covalent interfacial bonds bridging the MNL and the adjacent layers. In a particular example, thermal annealing facilitates the formation of strong siloxane bonds that do not revert to weak hydrogen bonded silanol groups. As a proof of concept, we show that introducing 3-mercapto-propyl-tri-methoxy-silane MNL at Cu-silica interface results in colossal >5-7 fold enhancement in interface strength when annealed at temperatures not lower than 400° C., compared to pristine interfaces.

The forgoing description of the invention has been presented for purpose of illustration and description. It is not intended to be exhaustive or limit the invention to the precise from disclosed, and modifications and variations are possible in light of the above teachings or may be acquired from practice of the invention. The description was chosen in order to explain the principles of the invention. The description was chosen in order to explain the principle of the invention and its practical application. It is intended that the scope of the invention be defined by the claims appended hereto, and their equivalents.

1. An article, comprising:
a first surface;
a second surface;
a molecular nanolayer located at an interface between the first and the second surface; and
wherein an interface toughness is higher than 20 J m⁻².

2. An article of claim 1, wherein:
the molecular nanolayer is a difunctional chemical;
the difunctional chemical has a formula A-(CHₓ—X)ₙ—B
A and B are same or different terminal groups;
X is an inorganic moiety or element; and
the terminal groups A and B are selected from Si(Y)ₙ wherein Y are selected from alkoxy groups (OCH₃)ₙ) or halides, SH, COOH, CN, NH₂, aromatic termini, CH₃, CH═CH₂, or (CHₓ)ₙ containing C—C, C═C or C≡C bonds in aliphatic or aromatic forms.

3.-4. (canceled)

5. An article of claim 1, wherein the molecular nanolayer comprises a branched or multilayer configuration.

6. An article of claim 1, wherein the first and the second surfaces are selected from an organic material, an inorganic material, or a combination thereof.

7. An article of claim 1, wherein:
the interface toughness is higher than 28 J m⁻²;
the molecular nanolayer has a thickness of less than 10 nm; and
the molecular nanolayer comprises a thiol terminated organosilane.

8.-10. (canceled)

11. An article of claim 7, wherein the molecular nanolayer comprises MPTMS or the molecular nanolayer contains irreversible siloxane bridging.

12. (canceled)

13. An article of claim 7, wherein the first and the second surfaces comprise first and second thin films, and the first film comprises a SiO₂ film and the second film comprises a Cu film.

14. (canceled)

15. An article comprising:
a first thin film;
a second thin film; and
a thiol terminated organosilane molecular nanolayer located at an interface between the first and the second thin film;
wherein:
the first and the second thin films are bonded to each other by the molecular nanolayer;
an interface toughness is higher than 20 J m⁻²; and
the molecular nanolayer contains irreversible siloxane bridging.

16. An article of claim 15, wherein the molecular nanolayer has a thickness of less than 10 nm.

17. An article of claim 16, wherein the molecular nanolayer comprises MPTMS, the first film comprises a SiO₂ film and the second film comprises a Cu film.

18. (canceled)

19. A bonding method comprising:
bonding a first surface to a second surface such that a molecular nanolayer is located between the first surface and the second surface; and
annealing the molecular nanolayer at a temperature above 400° C.

20. A method of claim 19, wherein the molecular nanolayer is formed on the first surface followed by providing the second surface on the molecular nanolayer followed by the annealing.

21. A method of claim 19, wherein:
an interface toughness between the first surface and the second surface is higher than 20 J m⁻²;
the annealing is performed at 500° C. to 700° C.;
the first and the second surfaces are selected from an organic material, an inorganic material, or a combination thereof; and
the first film comprises a SiO₂ film and the second film comprises a Cu film.

22.-24. (canceled)

25. A method of claim 19, wherein:
the molecular nanolayer is a difunctional chemical;
the difunctional chemical has a formula A-(CHₓ—X)ₙ—B;
A and B are chosen same or different terminal groups;
X is an inorganic moiety or element; and
the terminal groups A and B are selected from Si(Y)ₙ wherein Y are selected from alkoxy groups ((OCH₃)ₙ) or halides, SH, COOH, CN, NH₂, aromatic termini, CH₃, CH═CH₂, or (CHₓ)ₙ containing C—C, C═C or C≡C bonds in aliphatic or aromatic forms.

26.-27. (canceled)

28. A method of claim 19, wherein the molecular nanolayer comprises branched or multilayer configuration.

29. A method of 19, wherein the interface toughness is higher than 28 J m⁻² and the molecular nanolayer has a thickness of less than 10 nm.

30. (canceled)

31. A method of 19, wherein the molecular nanolayer has a thickness of 1 to 2 nm.

32. A method of 19, wherein the molecular nanolayer comprises a thiol terminated organosilane.

33. A method of 19, wherein the molecular nanolayer comprises MPTMS or the molecular nanolayer contains irreversible siloxane bridging.

34. (canceled)

35. A method of 19, wherein the first and the second surfaces comprise first and second thin films.
